(19) United States
(12) Patent Application Publication
(10) Pub. No.: US 2017/0302665 A1
(43) Pub. Date: Oct. 19, 2017

(54) NETWORK HOLOGRAM FOR ENTERPRISE SECURITY

(71) Applicant: Holonet Security, Inc., Sunnyvale, CA (US)

(72) Inventors: Feng Zou, San Jose, CA (US); Chunqing Cheng, San Jose, CA (US)

(21) Appl. No.: 15/465,480

(22) Filed: Mar. 21, 2017

Related U.S. Application Data
(60) Provisional application No. 62/311,856, filed on Mar. 22, 2016.

(51) Int. Cl. H04L 29/06; H04L 29/08; H04L 29/12; G06Q 20/20

(52) U.S. Cl. CPC H04L 63/0876; H04L 67/10; H04L 67/306; H04L 67/14; G06Q 20/204; H04L 63/1408; H04L 61/6022; H04L 61/2015; H04L 67/42

(57) ABSTRACT

The disclosed teachings include a computer-implemented method for discovering and building relationships between users, user devices, software applications, and data of a computer network in real-time. The method includes identifying a network session of a user device accessing a software application, and retrieving information of the network session including source and destination information, as well as a network protocol. The method includes identifying the software application based on the destination information and the network protocol, retrieving a media access control (MAC) address table or a dynamic host configuration protocol (DHCP) log from the network device, identifying a MAC address associated with the source information based on the MAC address table or the DHCP log. The method further includes determining an identity of the user device based on the identified MAC address, and recording the network session associating an identity of the user device with an identity of the software application.

### CROSS REFERENCE TO RELATED APPLICATION

This application claims priority to U.S. provisional patent application Ser. No. 62/311,856 filed Mar. 22, 2016, which is incorporated herein by reference in its entirety.

### TECHNICAL FIELD

The disclosed teachings relate to computer networks. In particular, the disclosed teachings relate to techniques for creating computer network representations for real-time visibility and anomaly detection of computer networks.

### BACKGROUND

A computer network is a communications network which allows interconnected nodes (e.g., computing devices) to share data and/or resources. The computing devices may exchange data over wired or wireless communication links. For example, an enterprise network is a common information technology (IT) infrastructure deployed today on all campuses by all sizes of organizations and across the globe. An enterprise network is used to maintain and communicate sensitive data. As such, enterprise networks include security features to prevent or mitigate data breaches.

Cloud computing is the practice of using a computer network of remote servers hosted on the Internet to store, manage, and process data, rather than using local servers or a personal computer. There has been a digital transformation as a result of an explosion of cloud-based applications and mobile device proliferation, which has extended the traditional boundaries of computer networks and raised, in tandem, the omnipresent challenge to protect data generated by disparate computing resources of computer networks, which are accessed and used from remote locations.

Network visibility refers to the ability to readily see (or quantify) the performance and activities of a computer network and/or applications running over the computer network. This visibility is what enables analysts to quickly identify security threats and resolve performance issues, ultimately ensuring a stable and reliable computer network. Expansive visibility and knowledge about how networked resources are being used, and by whom, and from where, has become a security mandate for enterprises to effectively protect their computing network and assets in this new, and ever-changing world of cloud computing. Unfortunately, existing network visibility tools are inadequate. As a result, computer networks remain susceptible to threats because analysts cannot take remedial measures for threats that cannot be adequately detected.

### SUMMARY

Introduced here is at least one computer-implemented method and one apparatus. In some embodiments, the disclosed teachings include a computer-implemented method for discovering and building relationships between users, user devices, software applications, and data of a computer network. The method includes identifying network session(s) of user device(s) accessing software application(s), and retrieving information of the network session(s) including source information (e.g., set of source IP address and port) and destination information (e.g., set of destination IP address and port), as well as a network protocol for each session. The method includes identifying the software application(s) based on the destination information and the network protocol, retrieving a media access control (MAC) address table or a dynamic host configuration protocol (DHCP) log from the network device, identifying a MAC address associated with the source information based on the MAC address table or the DHCP log. The method further includes determining an identity of a particular user device based on its identified MAC address, and recording a particular network session associating an identity of the particular user device with an identity of a particular software application being accessed by the user device in a particular network session.

In some embodiments, the software application is a cloud-based application residing on a remote server computer accessible by the user device over a wide area network. In some embodiments, the software application resides on a server computer of a local area network of the user device.

In some embodiments, an apparatus such as a server computer is operable to perform the aforementioned computer-implemented method.

### BRIEF DESCRIPTION OF THE DRAWINGS

FIG. 1 illustrates a point-of-sale system susceptible to security attacks from a malicious actor;

FIG. 2 illustrates a data flow diagram for a system that can detect security attacks from a malicious actor;

FIG. 3 illustrates stages for creating a network representation according to some embodiments of the present disclosure;

FIG. 4 illustrates a data flow of a detection system for real-time visibility and anomaly detection according to some embodiments of the present disclosure;

FIG. 5 illustrates systems including a real-time visibility and anomaly detection system according to some embodiments of the present disclosure;

FIG. 6 is a flowchart illustrating a process for discovering and building a representation of a computer network for real-time visibility and anomaly detection according to some embodiments of the present disclosure; and

FIG. 7 is a block diagram of a computer operable to implement the disclosed technology according to some embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of the concepts that are not particularly addressed herein. It should be understood that these concepts and applications fall within the scope of the accompanying claims.

The purpose of terminology used herein is only for describing embodiments and is not intended to limit the scope of the claims. Where context permits, words using the singular or plural form may also include the plural or singular form, respectively.

As used herein, unless specifically stated otherwise, terms such as “processing,” “computing,” “calculating,” “determining,” “displaying,” “generating,” or the like refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, the terms “connected,” “coupled,” or variants thereof, refer to any connection or coupling, either direct or indirect, between two or more elements. The coupling or connection between the elements can be physical, logical, or a combination thereof.

As used herein, a “network hologram” refers to a representation of the relationship among four security vectors—user, device, application, and data. Almost all security incidents or data breaches will lead investigators to answer the following questions: what happened (what data is compromised), who did it, using what device, from where.

The representation may be used to determine activity of the computer network, which can be used to mitigate actual or potential security threats such as data breaches, and identify data breaches that have already occurred.

The emergence of cloud computing has permitted organizations to expand their ability to exchange data over seemingly unbounded computer networks. For example, a multinational corporation with locations in different parts of the world can readily share data over cloud-based networks (e.g., the Internet) to maintain harmonious operations across its locations. Individual users have also benefited from advances in cloud computing by offloading both computing and storage processes to remote resources. As a result, any user or organization of any size can readily expand or contract its network to include any available cloud computing resources without needing to purchase or build a proprietary infrastructure.

The demand for elastic scalability combined with the ease of access to cloud resources has drastically improved user experience. In combination with the proliferation of mobility due to the ubiquitous availability of mobile devices, existing computer networks are far more accessible and routinely used to communicate data, including critical or private data. The ubiquitous nature of computer networks and interconnectivity has also created many risks for users because data shared across public networks is susceptible to being stolen without anyone noticing the data breach.

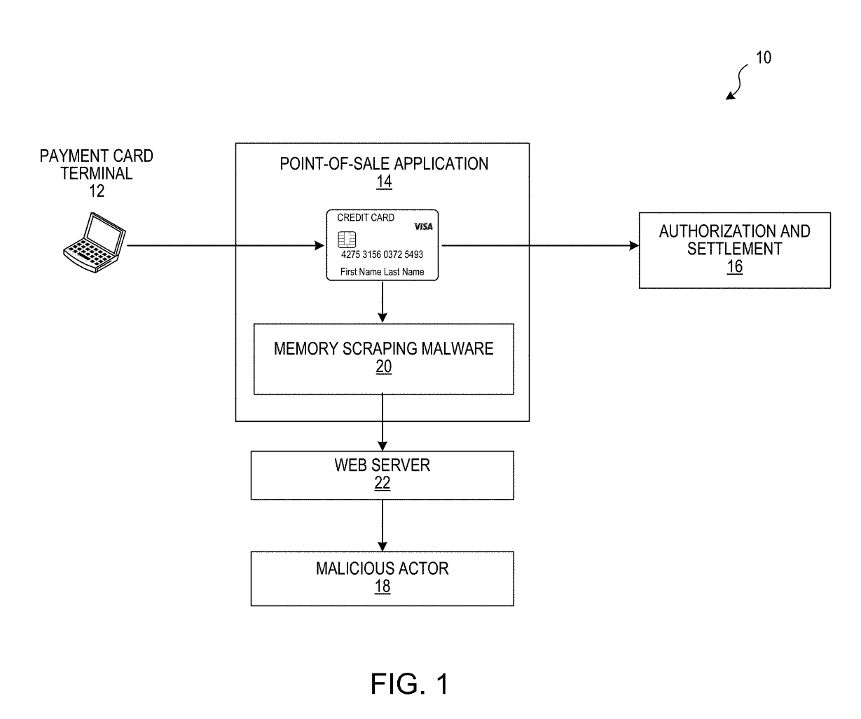

FIG. 1 illustrates a point-of-sale (POS) system susceptible to security attacks from a malicious actor. The system 10 is implemented by retail stores and functions analogously to payment systems used by online commerce sites. The system 10 includes a payment card terminal 12 where a consumer can pay to purchase goods or services by using forms of payments such as a credit card. The payment card terminal 12 is communicatively coupled to a POS application 14 that processes a payment by exchanging sensitive consumer data with an authorization and settlement system 16. In some cases, the POS application 14 can be a cloud-based subscription service commonly referred to as a “software as a service” (SaaS). The sensitive consumer data is communicated over a computer network to obtain authorization and settlement of a payment. As a result, the sensitive consumer data can be stolen for malicious purposes by virtue of the fact that it is carried on a network.

The system 10 also illustrates a data breach cause by a malicious actor 18 seeking to obtain and possibly misuse the consumer data. For example, the malicious actor 18 may seek to steal consumer credit card data to make illegal purchases. As shown, the POS application 14 was infected with memory scraping malware 18 acting on behalf of the malicious actor 18 via a web server 22. The malware 20 may be software that infiltrated the POS application 14 to cause the data breach. In operation, the malware 20 can extract sensitive consumer data such as names, addresses, credit card numbers, and PIN numbers. This type of data breach can result in losses of billions of dollars for any entity that implements the system 10. Moreover, the risk of identity fraud increases because personal consumer information is communicated over the computer networks used to complete the POS transaction.

Network security measures have been increasingly more important in this world of interconnected computing resources. A network security measure typically involves identifying network vulnerabilities and then taking remedial measures to stop or prevent security attacks on the computer network. The ability to stop or prevent security attacks requires visibility into the computer network to identify any actual or potential vulnerabilities. In particular, network security requires the ability to readily see (or quantify) the performance and activities of computer networks and/or its applications to determine any suspicious anomalies. This visibility enables analysts to quickly isolate security threats and resolve issues, ultimately ensuring a secure computer network.

The current digital transformation has created a new threat landscape as sensitive business data flows across a distributed enterprise. In particular, the vast majority of security incidents and breaches result from sensitive data being moved or tampered with in illegitimate ways. Accordingly, a central goal of enterprise networks is to provide robust data security. Even though enterprise networks deploy a number of security measures for network protection, application protection and threat detection, the measures offer no visibility into what happens to data before or during breaches (e.g., in real-time), and provide inadequate insights into attacks that already occurred.

Existing tools try to provide analytics and visibility into corporate networks. For example, security information and event management (SIEM) software consumes logs from all kinds of network devices, servers, and end-unit devices. Since most of these logs were not designed for SIEM tools or for security purposes (i.e., instead are primarily used for the purpose of debugging and auditing), SIEM has failed to meet the expectation to provide the needed visibility and intelligence, especially in real-time.

For example, when two files with different names are sent to different geo-locations from different applications through different user devices, a SIEM tool cannot tell that even though the two files have different names, they are actually the same file. It won't be able to tell that the two devices are actually used by the same person, therefore all these activities belong to one person. Without understanding the nature of how packets are being modified and transferred from network layers to application layers across network nodes, SIEM tools cannot uncover any insights or meaning from the logs, which do not include any indication of inherited relationships within and between packet traffic from users to devices, applications, and data.

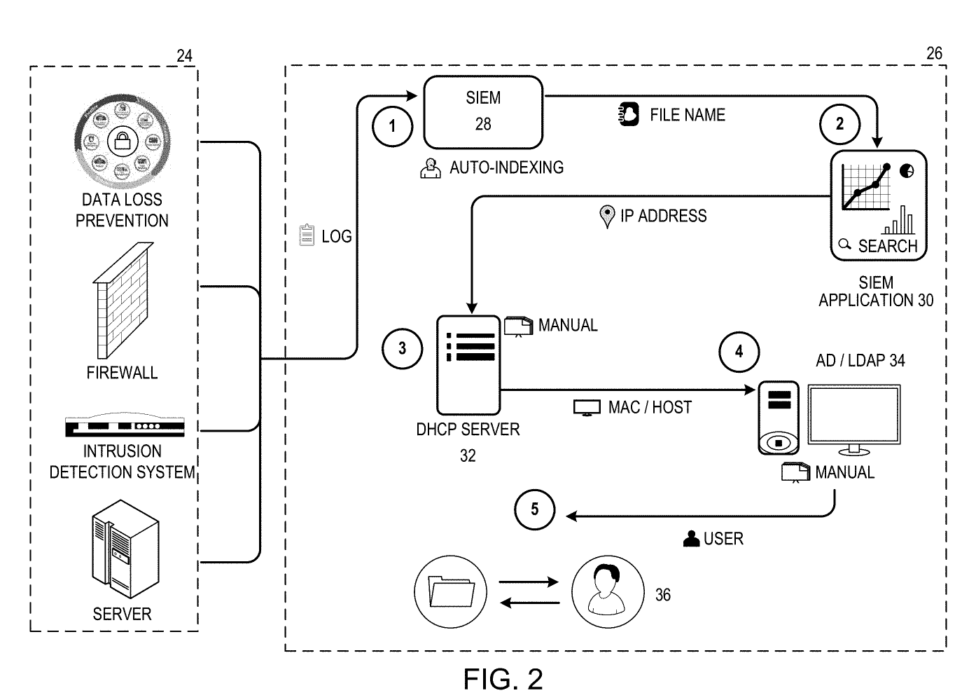

FIG. 2 illustrates a data flow diagram for a system that can detect security attacks from a malicious actor. As illustrated, various network security mechanisms 24 are coupled to a security system 26. The security mechanisms 24 include data loss prevention techniques, a firewall, an intrusion detection system, and a server for security services. The security mechanisms 24 operate to log data, which is collected by a SIEM 28. The SIEM 28 can analyze the log data, and detect abnormal activities in the network layer. In order to find out how a data breach has happened, for example, how a confidential document was compromised, SIEM 28 can map a document name to an IP address which was used to move the document. A SIEM application 30 can then generate a visualization or report indicative of security breaches that previously occurred in the computer network.

A dynamic host configuration protocol (DHCP) server 32 can manually obtain Internet Protocol (IP) addresses of suspicious networked computers from the SIEM application 30. Note that a DHCP server is used to allocate IP addresses for a computer. These IP addresses are typically private addresses. An IT team member can map out the MAC address of a computer from the private IP address. Since a MAC address is globally unique, the MAC address can be used to represent a computing device. The DHCP server 32 provides related MAC/host information to an active directory/lightweight directory access protocol (AP/LDAP) device 34, which an analyst can use to manually identify suspected users causing the data breach. Hence, such systems only provide information about an attack that previously occurred, but cannot provide real-time visibility of suspicious activity based on data movements. Accordingly, existing systems provide limited visibility without fully knowing who's moving data, what device is being used to move the data, and the location from where the data is being moved, in real-time to prevent or mitigate data breaches.

In addition to SIEM, which consumes massive volume of irrelevant logs to provide a “garbage In, garbage out” detection, other security mechanisms include network and application security (but not data security) tools such as next-generation firewall (NGFW); blind hard-coded enforcement for sensitive data without any visibility such as data loss prevention (DLP); user focused measure that have no data visibility and do not operate in real-time such as user and entity behavior analytics (UEBA); SaaS data security, which has no visibility to internal data movement such as a cloud access security broker (CASB); and endpoint solutions with agents installed but without an overall global view such as endpoint detection and response (EDR).

Each of these existing solutions have many of the same drawbacks. First, execution of existing solutions requires operators to manually perform work to map out moved data with actual users. Second, existing solutions also act too late. For example, existing solutions can typically identify a data breach several weeks or months after the breach has occurred, which is too late to effectively mitigate the effect of the breach. Third, existing solutions only provide a limited (partial view) of the network, typically limited to either cloud-based applications or individual internal applications, but provide no holistic overall picture of the computer network. Fourth, existing solutions are too costly. In particular, entities need to maintain a pool of experts on each individual security product to work together through manual processes.

To solve the drawbacks of opaque network behavior, late analytics, and incomplete snapshots of network threats, the disclosed embodiments introduce a “network hologram” that can give an enterprise full spectrum visibility of many or all activities within its corporate network in real-time or near real-time. In other words, the disclosed technology provides improved visibility into network activities in terms of both depth and breadth, and provides the visibility in real-time. As such, the disclosed technology provides substantial benefits over existing technology and solves the aforementioned drawbacks. The technology can be deployed seamlessly with an existing ecosystem without needing to change network topology or needing a complicated configuration.

Thus, the disclosed technology provides significant benefits over existing security systems. First, it offers real-time capabilities. Hence, the disclosed technology provides instant visibility and anomaly detection as data is being moved. Second, the disclosed technology provides expansive or full visibility. For example, the disclosed technology covers both internal data movements and outbound or inbound movements to and from a computer network coupled to the Internet. Third, the disclosed technology is cost-efficient compared to existing solutions. For example, the disclosed technology can automate all the manual processes of existing solutions.

### I. Network Hologram

An organization that handles sensitive data typically seeks visibility into movement of that data inside and outside of its networks to identify actual or potential security threats such as data breaches. For example, a corporation seeks to know if data is communicated from its local network to an external network via a cloud-based application being accessed from within the corporation's network. Any unusual movement of data could be indicative of a data breach. For example, frequent movement of rarely accessed data would be indicative of a data breach.

The disclosed embodiments include a network hologram for providing real-time visibility into the movement of data in computer networks. A network hologram is a representation of the re-constructed relationship among four critical security vectors—user, device, application, and data/file, based on data obtained from the computer network. The representation may be used to determine activity occurring on the computer network, which can be used to detect, identify, terminate, or prevent security threats such as data breaches.

In some embodiments, there are four necessary and sufficient core elements associated with data that any enterprise security team can obtain in unison from a computer network to detect security threats. Hence, the network hologram allows for achieving greater security visibility of a corporate environment. In particular, the four elements can be used by an enterprise to identify any data in real-time, to detect any unauthorized activity indicative of a data breach by a party seeking to steal that data. As such, data can be uniquely identified by its particular relationship among these elements.

A network hologram can be established by uncovering and reconstructing relationships between these elements for data of a computer network. In some embodiments, the necessary and sufficient elements are a user, user device, software application, and data/files (UDAD). The first element is a “user” element, which represents a person or entity that can directly or indirectly manipulate data. For example, humans are users that can cause malicious activity, intrusions, data breach, and loss. Accordingly, with respect to detecting a security threat, the first question people will ask and have a keen desire to uncover is “who did it,” and identifying the user element would answer this question.

The second element is a “user device” element, which represents a user device associated with a user element. For example, the user device element can represent a device that an individual person is using to manipulate data. Hence, a user device element can be used to answer the question of where and when data is moved, which is important because a user device is the mechanism and machine that sends and receives data for the user.

The third element is a “software application” element, which is associated with handling the data sent and received by the user device. A software application can refer to what type of application is being used for what purpose, when data is being moved on the computer network. Hence, a corporate entity would like to know which software application is involved in order to help uncover details of this activity and uncover the data being manipulated.

The fourth element is a “data or file” element, which represents the data being manipulated (created or moved) in the computer network. In some cases, the file/data element is the most popular in the format of files. This element can be the single most critical element for any enterprise, especially in the age of cloud computing where machines, software applications, and the entire computing infrastructure may be provided by third-parties, where unknown elements can originate from.

These UDAD elements, along with their inherited relationships, can be used to form a complete representation of the real-time activity of a computer network. Hence, these four elements and their internal relationships can be collectively referred to as the network hologram of the computer network over which the data traverses. By using the network hologram, any data that traverses the computer network can be traced back to a user and/or user device.

To aid in understanding the significant utility of the network hologram, a hypothetical example is considered. In this example, a computer network has a single user, Joe. When Joe uses his devices, such as a MACBOOK or IPHONE (personal or corporate-owned) to connect to the internet, using applications such as GOOGLE, YAHOO, and so forth, logging into cloud application accounts by using an email address credential, such as Joe@Holonetscurity.com for a user identification for BOX.NET or Joe@gmail.com for GDRIVE, and downloading a number of files. In this case, there exists a clear singular association (e.g., ownership) of all UDAD elements; that is, all UDAD elements of the data are associated with Joe. The inherited relationship from Joe to login names, user devices, software applications, and data is unambiguous because Joe is the only user of the computer network. That is, everything is aggregated under one person—Joe.

Now consider adding a second user, Sam, to the computer network. This example starts to get murkier because Sam may have multiple devices, accessing multiple applications, some of which may be the same type devices or software applications accessed as Joe, using multiple emails to log-in to cloud services, and download/upload a number of files, some of which may be shared with Joe. Hence, the relationships between Joe or Sam and their devices, credentials, software applications and data is ambiguous without knowing the linkage among respective elements.

By extension, consider a corporate network with thousands of users, thousands of user devices, tens of thousands of software applications and files that are manipulated by different users. In such cases, a security administrator cannot readily and unambiguously identify the relationship from a user to her login names, devices, applications, and data. In contrast, from a single user example, the unambiguous relationship is clear—each software application used or file move must be associated with a user device, and each device must be operated by a person (or automated by a hacker). Therefore, being able to uniquely discover and reconstruct the relationship between a user, devices, applications, and files/data is the foundation of enterprise information security.

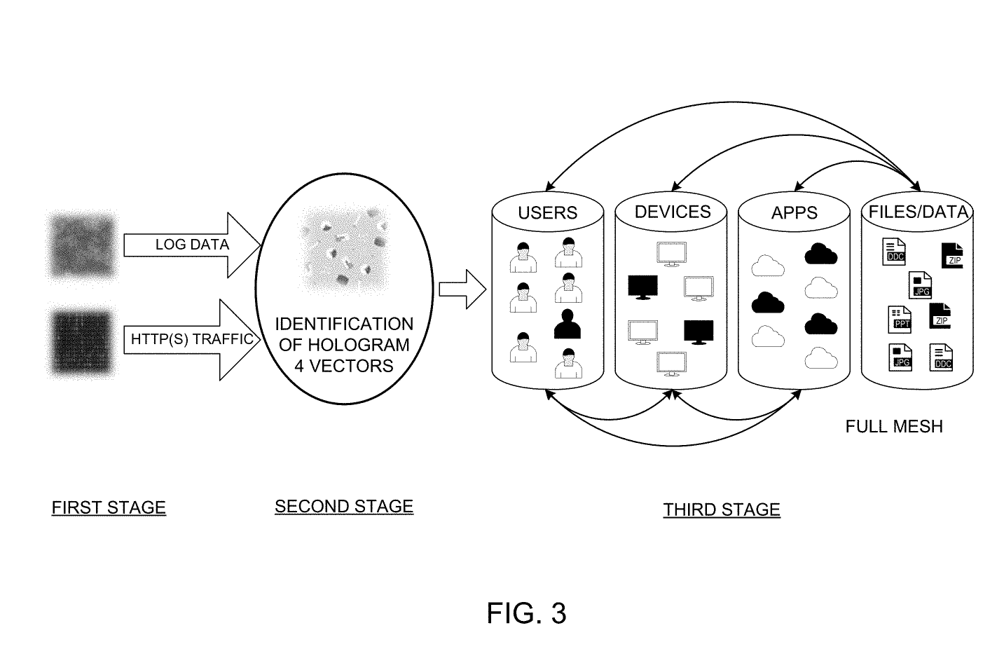

To aid in understanding, FIG. 3 illustrates stages for creating a network hologram according to some embodiments of the present disclosure. In particular, the creation of a network hologram is illustrated as a series of stages beginning from collecting data of a computer network and leading to the eventual discovery and building of relationships between users, user devices, software applications and the moved data. The elements and their relationships create the network hologram that allows security teams to discover and trace unusual activity on computer networks.

In the first stage, metadata is captured from selected traffic (e.g., HTTPs), and fed to a behavioral analytics engine along with other metadata from the associated network device. At a second stage, hologram vectors are identified. A hologram vector includes elements such as users, user devices, software applications, files/data, and the like. In the illustrated example, hologram vectors have four uniquely identifiable elements: user credentials, user devices, software applications, and files/data. The relationships between the elements can be established in various ways. For example, unknown relationships across these four vectors can be uncovered and maintained in the third stage via machine-learning. The discovery and building of relationships of elements allows for real-time identification of abnormal behavior of users and data, and enables mitigating possible security threats by automatically altering network configurations or issuing warnings to a network security operator to manually trigger remediation measures.

### II. Uniquely Identifying Elements of a Network Hologram

Disclosed herein are several ways to identify the aforementioned elements used to build a network hologram of a unique computing environment such that the relationship among the (e.g., four) elements can be unambiguously described.

In some embodiments, the user element can be defined or identified by associated email address aliases. For example, enterprises can identify employees by email address aliases. Likewise, SaaS service vendors use email address aliases to identify their users. Regardless of who issues the aliases, email addresses are globally unique. Hence, email addresses are commonly used to uniquely identify users. In some case, a single user may have multiple email addresses, each being used for different purposes or software applications. From a security perspective, linking all the user's email addresses together to reflect the fact that all these aliases are associated with one person has a significant impact to reconstruct the relationships among the elements of a network hologram. User element can also be identified by the user names in the AD/LDAP system, or login names used for different applications.

In some embodiments, the user device element can be identified by its Ethernet interface port. For example, every network device in a corporate network has at least one Ethernet interface port, which has a six-byte (48 bits) physical address, referred to as a media access control (MAC) address. The IEEE assigns MAC address ranges to particular companies. The first three bytes (24 bits) of the MAC address comprise an organizational unique identifier (OUI) that identifies the manufacturer. The last three bytes represent a unique identification number for a network interface card (NIC) of the manufacturer. Since a MAC address is globally unique, the simplest way to identify a user device can be through its Ethernet card's MAC address. However, device identification is not limited to MAC addresses. For example, technologies such as device fingerprinting can also be used to identify a device.

In some embodiments, a software application can be uniquely identified by its domain name. For example, in the age of cloud computing, SaaS services can be identified by the service provider's domain names (DN). The right to use a DN is delegated by DN registrars, which are accredited by the Internet Corporation for Assigned Names and Numbers (ICANN). A fully qualified DN (FQDN) is the complete DN that a specific computer or host on the Internet is designated. The FQDN consists of two parts: the hostname, which is controlled by the enterprise, and the domain name, which is delegated by the registrars. Therefore, FQDNs are globally unique. Most of the applications are hosted under specific FQDNs. As such, FQDNs can be used as primary identifiers for any applications. The same mechanism can also be used to identify internal applications (e.g., running onsite).

In some embodiments, files are the most popular and prevailing way to represent data in a typical network environment. A content fingerprint such as a hash number of a file can be nearly unique globally in its raw form. Combined with other content attributes, such as content length and type, the hash number can be used to identify a unique file for a given entity. Since any segment of data can be fingerprinted on-the-fly, a hash number can be used to represent any data beyond just files.

Thus, the aforementioned embodiments collectively use 1) email address aliases, 2) MAC addresses, 3) FQDNs, and 4) file fingerprints to represent the four (UDAD) elements of a network hologram. This concept can be generalized to use alternative, additional, or fewer elements to construct a network hologram as could be reasonable understood by persons skilled in the art.

### III. Discovering and Building Relationships of a Network Hologram

Although a network hologram requires defining elements and the ability to identify each element in a unique way, such information is insufficient to construct a network hologram used to mitigate network attacks. The original relationship between a user and the user's devices, software applications, and data should be discovered to build the network hologram. The user may be associated with any number of email credentials (e.g., aliases), user devices, applications, and files. The disclosed embodiments build the network hologram by linking the user with the user's email aliases, devices, software applications, and data in such a way that even when hundreds or thousands of users share the same computer network, an unambiguous relationship clearly persists, just as if a user was the only user of the computer network. For example, TABLE 1 describes a network hologram for a given user.

TABLE 1

| User Aliases | Devices | Applications | Data/Files |
|---|---|---|---|
| Name1@yahoo.com | MACBOOK AIR | BOX.NET | Abc.pdf |
| Name2@gmail.com | IPAD 2 | GDRIVE | Def.docx |
| Name3@abc.com | IPHONE 6 | SALESFORCE | Jfk.xls |
| | DELL laptop | YAHOO | Npq.txt |
| | | YOUTUBE | Rst.ppt |
| | | | Xyz.doc |

By combining the metadata from network and application layers, the disclosed embodiments present a method to bind a representation of a user with the user's different credentials, such as login names or email address aliases together vertically, (i.e., for the user aliases column of TABLE 1), and also horizontally links the user with the user's devices (i.e., device column), with the device's application, and with the application's data. The links among all these elements are detailed below.

When a user device accesses an application, a network session is established with five-tuples: source IP, destination IP, source port, destination port, and network protocol. The destination IP, destination port, and protocol are associated with a particular software application. The source IP and source port are associated with the originating device. This session information can be obtained from firewalls or other network devices such as switches or routers. If the source (originating) device is connected to a firewall (or other layer-3 device) directly or through a layer-2 switch, the firewall will carry the MAC address of the source device in its MAC table (or other table, such as a session table), which links the device's MAC address to its IP address (source IP address). Since the network session also maps the source IP with the destination application, the disclosed technology can link the source MAC address, which identifies the source device, with the destination software application (e.g., cloud application or internal application), thus connecting the source device with its software applications.

In a more complex network where the source device is connected to the firewall through one or multiple intermediate layer-3 switches (or other devices), the MAC address of the device will be transparent to the firewall so the session table will not map the user device directly to the software applications that it uses. In this scenario, other information can be used to connect the source IP with the source MAC address, such as log data or traffic from DHCP servers. Most user device IP addresses in a corporate network are allocated through one or more DHCP servers, which binds a user device's MAC address with its IP address. Since a source device's IP address is part of the network session, unless the source IP is translated to a different IP through another network address translation (NAT) device; in which case, the network session should be obtained from this intermediate NAT device. This allows for mapping that source IP to the MAC address, thus, connecting the user device with the network session and its software application.

In some embodiments, a user device fingerprint can be used instead of its MAC address to identify the user device and map the user device to its software applications. Either way, the user device column of TABLE 1 is linked with the application column of TABLE 1. The linkage between a software application and its data is tightly coupled by nature since data is part of the packets being transferred throughout the networks. Every network packet is associated with a session and, as such, so is its data. Therefore, data is connected to its software application and a user device through their session, linking the data column of TABLE 1 with device and application columns of TABLE 1. By linking all user emails with their devices, the loop is closed from user to the user's devices, software applications, and data. As such, a full network hologram can be created.

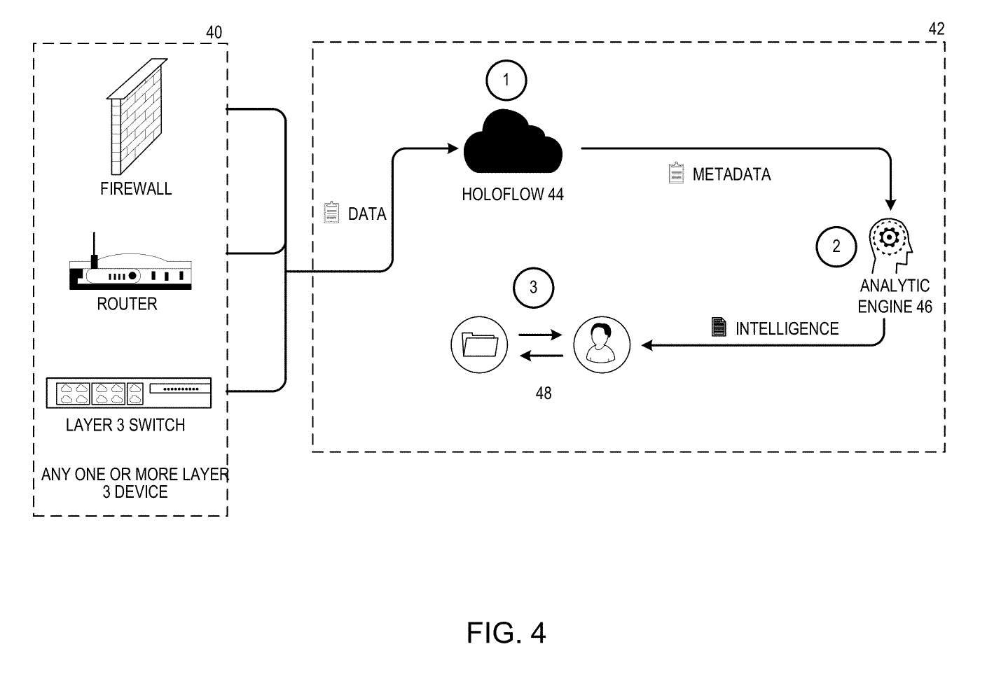

FIG. 4 illustrates a data flow of a detection system for real-time visibility and anomaly detection according to some embodiments of the present disclosure. As shown, any one of more layer 3 devices 40 is connected to a network security system 42. The traffic data and metadata from the layer-3 devices 40 are collected by the “HoloFlow” agent 44. The HoloFlow agent 44 generates its own metadata. The combined metadata can then be fed to an analytics engine 46 by the HoloFlow agent 44. The analytics engine 46 can then build a network hologram to link a user with the data/file to detect network anomalies in real-time, and determine suitable remediation measures.

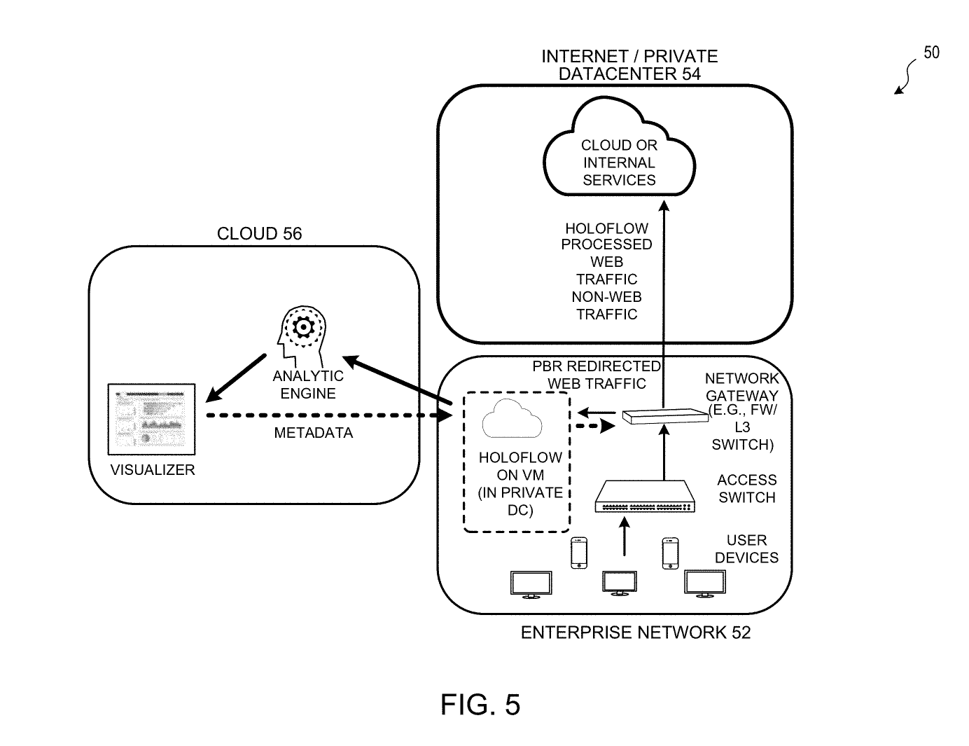

FIG. 5 illustrates systems including a real-time visibility and anomaly detection system according to some embodiments of the present disclosure. The illustrated systems include an enterprise network 52. The enterprise network 52 includes user devices coupled to an access switch, further coupled to a network gateway (e.g., a layer 3 switch, a router, or a firewall), which couples the enterprise network 52 to an internet (public) or a private datacenter 54. The datacenter 54 includes cloud or internal services that are accessed by the user devices of the enterprise network 52 via its access switch and network gateway.

The illustrated embodiment includes a HoloFlow agent running on a VM executing on a device of the enterprise network 52. The HoloFlow agent collects traffic traversing the datacenter 54 and the enterprise network 52, and captures/generates proper metadata, such as user credentials, file names, session info and send them to an analytic engine in the cloud 56. The analytic engine of the cloud 56 builds a network hologram based on the data obtained from the HoloFlow agent residing on the enterprise network 52. In particular, the analytic engine can build the network hologram as described above with reference to TABLE 1, for each user of the enterprise network 52. As such, the analytic engine can monitor network activity in real-time to identify suspicious behavior such as anomalous movement of data from a user device to a cloud service.

In some embodiments, the disclosed technology includes a visualizer tool used to visualize the monitoring by the analytic engine. For example, a user interface can be rendered on a computer accessible by an analyst monitoring the enterprise network 52 for suspicious activity. The visualizer tool may create graphs indicating anomalous activity, alerts of threats, and/or suggest adequate remediation measures. In some embodiments, the visualizer tool can send metadata back to the enterprise network 52 for its own use in performing an analysis of the network.

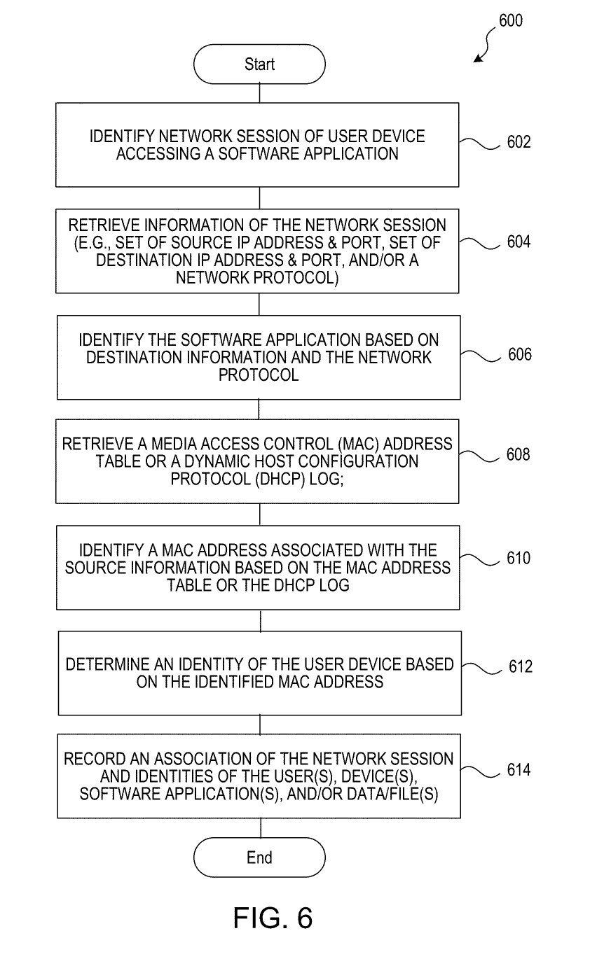

FIG. 6 is a flowchart illustrating a process for discovering and building a representation (e.g., network hologram) of a computer network for real-time visibility and anomaly detection according to some embodiments of the present disclosure. In particular, the computer-implemented method 600 relates to discovering or building relationships between users, devices, software applications, and data of a computer network. In step 602, a security system identifies a network session of a user device accessing a software application.

In step 604, information of the network session is retrieved from, for example, a network device. The retrieved information may include source information and/or destination information for the network session. An example of source information is a set of source IP address and port. An example of destination information is a set of destination IP address and port.

In step 606, the software application is identified based on, for example, the set of destination IP address and destination port and the network protocol. In some embodiments, the software application is a cloud-based application residing on a remote server computer accessible by the user device over a wide area network (e.g., the Internet). In some embodiments, the software application resides on a server computer of a local area network of the user device. As such, the subsequently formed network hologram can be used to monitor traffic exclusively within a corporate network and/or traffic moving to or from a wide area network.

In step 608, a MAC address table or a DHCP log is retrieved from the network device. In step 610, a MAC address associated with the source IP address is identified based on the MAC address table or the DHCP log. In step 612, the security system determines an identity of the user device based on the identified MAC address.

In step 614, the security system records the network session associating the identity of the user device with an identity of the software application. The association of elements contributes to the formation of a network hologram for real-time visibility and anomaly detection of data in the computer network. In some embodiments, the recording of the network session can associate an identity of the user with the identity of the user device and the identity of the software application. For example, the user may have one or more email addresses that can be associated with the network session. The recording of the network session may also associate the user device and software application with one or more other elements such as files, data, additional user devices, or software applications. Hence, the associations can be used to discover or build relationships of the network hologram.

For example, in one use case, an employee's laptop and login credentials are compromised by a hacker seeking to steal sensitive data from a company network. Prior systems could not readily identify if an access to the sensitive data is normal or unusual behavior indicative of a security threat by the hacker. At best, prior systems could only learn about a data breach days or months after the data was compromised.

These drawbacks are overcome by the disclosed technology, which can identify unusual behavior such as types of sensitive files being moved (e.g., financial documents moved from enterprise server). The data movement is linked with a user and devices in real-time (e.g., a CFO moving the financial documents from the enterprise server). The security system can learn patterns of how the data is normally accessed to build a profile of normal behavior. When the hacker gets control of the laptop, the pattern changes (e.g., source code is accessed from a second server). Accordingly, the disclosed technology can detect such unusual behavior indicative of a security threat.

### IV. Computing Device

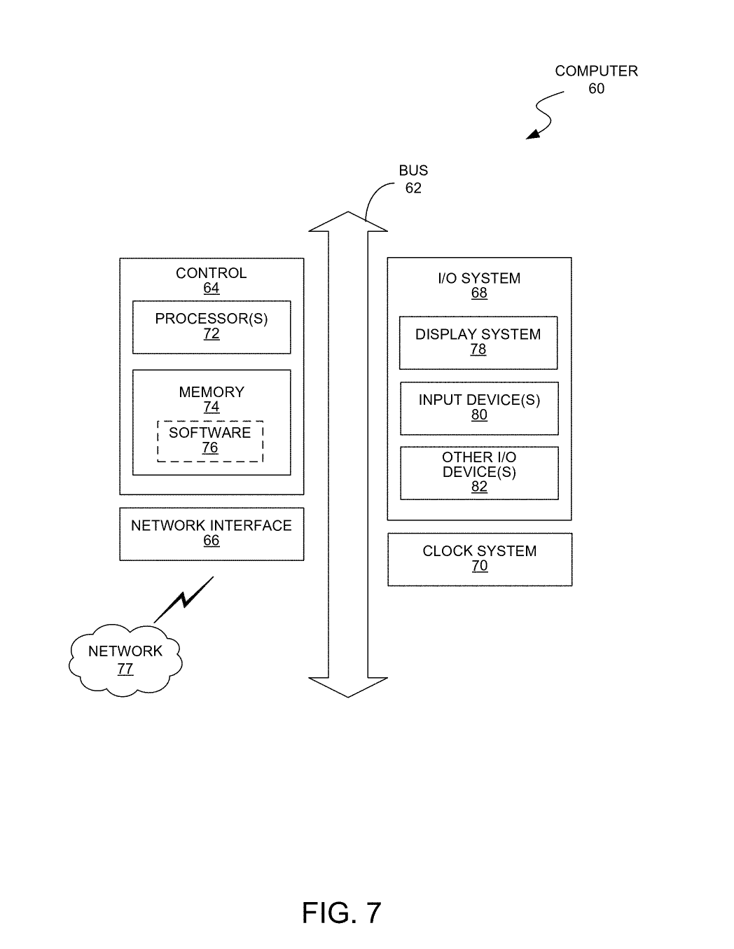

FIG. 7 is a block diagram of a computer 60 operable to implement the disclosed technology according to some embodiments of the present disclosure. The computer 60 may be a general computer or a device specifically designed to carry out features of the disclosed technology. For example, the computer 60 may be a network device, a system-on-chip (SoC), a single-board computer (SBC) system, a desktop or a laptop computer, a kiosk, a mainframe, a mesh of computer systems, a handheld mobile device, or combinations thereof.

The computer 60 may be a standalone device or part of a distributed system that spans multiple networks, locations, machines, or combinations thereof. In some embodiments, the computer 60 operates as a server computer (e.g., a network server computer running an analytic engine or HoloFlow) or a mobile device (e.g., a user device of the enterprise network 52) in a network environment, or a peer machine in a peer-to-peer system. In some embodiments, the computer 60 may perform one or more steps of the disclosed embodiments in real time, near-real time, offline, by batch processing, or combinations thereof.

As shown, the computer 80 includes a bus 62 operable to transfer data between hardware components. These components include a control 64 (i.e., processing system), a network interface 66, an Input/Output (I/O) system 68, and a clock system 70. The computer 60 may include other components not shown, nor further discussed for the sake of brevity. One having ordinary skill in the art will understand any hardware and software included but not shown in FIG. 7.

The control 64 includes one or more processors 72 (e.g., central processing units (CPUs), application-specific integrated circuits (ASICs), and/or field-programmable gate arrays (FPGAs)) and memory 74 (which may include software 76). The memory 74 may include, for example, volatile memory such as random-access memory (RAM) and/or non-volatile memory such as read-only memory (ROM). The memory 74 can be local, remote, or distributed.

A software program (e.g., software 76), when referred to as “implemented in a computer-readable storage medium,” includes computer-readable instructions stored in a memory (e.g., memory 74). A processor (e.g., processor 72) is “configured to execute a software program” when at least one value associated with the software program is stored in a register that is readable by the processor. In some embodiments, routines executed to implement the disclosed embodiments may be implemented as part of operating system (OS) software (e.g., MICROSOFT WINDOWS, LINUX) or a specific software application, component, program, object, module, or sequence of instructions referred to as “computer programs.”

As such, the computer programs typically comprise one or more instructions set at various times in various memory devices of a computer (e.g., computer 60) and which, when read and executed by at least one processor (e.g., processor 97), cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., the memory 74).

The network interface 66 may include a modem or other interfaces (not shown) for coupling the computer 60 to other computers over the network 77. The I/O system 68 may operate to control various I/O devices, including peripheral devices such as a display system 78 (e.g., a monitor or touch-sensitive display) and one or more input devices 80 (e.g., a keyboard and/or pointing device). Other I/O devices 82 may include, for example, a disk drive, printer, scanner, or the like. Lastly, the clock system 70 controls a timer for use by the disclosed embodiments.

Operation of a memory device (e.g., memory 74), such as a change in state from a binary one to a binary zero (or vice versa), may comprise a perceptible physical transformation. The transformation may comprise a physical transformation of an article to a different state or thing. For example, a change in state may involve accumulation and storage of charge or release of stored charge. Likewise, a change of state may comprise a physical change or transformation in magnetic orientation, or a physical change or transformation in molecular structure, such as from crystalline to amorphous or vice versa.

Aspects of the disclosed embodiments may be described in terms of algorithms and symbolic representations of operations on data bits stored on memory. These algorithmic descriptions and symbolic representations generally include a sequence of operations leading to a desired result. The operations require physical manipulations of physical quantities. Usually, though not necessarily, these quantities take the form of electric or magnetic signals capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms, and that the disclosure applies equally regardless of the particular type of machine or computer-readable media used to actually effect the distribution.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

1. A computer-implemented method for discovering or building relationships between users, devices, software applications, and/or data of a computer network in real-time, comprising:
identifying a network session of a user device accessing a software application;
retrieving, from a network device, information of the network session including a set of source IP address and port, a set of destination IP address and port, and a network protocol;
identifying the software application based on the set of destination IP address and destination port and the network protocol;
retrieving a media access control (MAC) address table or a dynamic host configuration protocol (DHCP) log from the network device;
identifying a MAC address associated with the source IP address based on the MAC address table or the DHCP log;
determining an identity of the user device based on the identified MAC address; and
recording the network session associating the identity of the user device with an identity of the software application.

2. The computer-implemented method of claim 1, further comprising:
recording the network session associating an identity of the user with the identity of the user device and the identity of the software application.

3. The computer-implemented method of claim 2, wherein the identity of the user is an email address or a login name of any application.

4. The computer-implemented method of claim 1, further comprising:
recording the network session associating one or more files with the identity of the user device and the identity of the software application.

5. The computer-implemented method of claim 1, further comprising:
recording the network session associating data with the identity of the user device and the identity of the software application.

6. The computer-implemented method of claim 1, wherein the identity of the user device is a first identity of a first user device, the method further comprising:
recording the network session associating a second identity of a second user device with an identity of the software application.

7. The computer-implemented method of claim 1, wherein the identity of the application is a first identity of a first software application, the method further comprising:
recording the network session associating the identity of the user device with a second identity of a second the software application.

8. The computer-implemented method of claim 1, wherein the software application is a cloud-based application residing on a remote server computer accessible by the user device over a wide area network.

9. The computer-implemented method of claim 1, wherein the software application resides on a server computer of a local area network of the user device.

10. A computer-implemented method performed by one or more computing devices operable to discover or build relationships of a plurality of elements of a computer network, the method comprising:
identifying a network session of a user device accessing a software application;
retrieving information of the network session including at least one of a source information, destination information, and a network protocol;
identifying the software application based on the destination information and the network protocol;
retrieving a media access control (MAC) address table or a dynamic host configuration protocol (DHCP) log from DHCP traffic;
identifying a MAC address associated with the source information based on the MAC address table or the DHCP log;
determining an identity of the user device based on the identified MAC address; and
recording the network session associating the identity of the user device with an identity of the software application.

11. The computer-implemented method of claim 10, wherein the plurality of elements includes any of a user, a user device, a software application, or data of the computer network.

12. The computer-implemented method of claim 10, wherein the plurality of elements includes users, user devices, software applications, and data.

13. The computer-implemented method of claim 10, wherein the software application is a cloud-based application residing on a remote server accessible by the user device over a wide area network.

14. The computer-implemented method of claim 10, wherein the software application resides on a server of a local area network accessible by the user device.

15. The computer-implemented method of claim 10, wherein the MAC address table or DHCP log is retrieved from is a network device.

16. The computer-implemented method of claim 10, wherein the source information is a set including a source IP address and port of the network session.

17. The computer-implemented method of claim 10, wherein the destination information is a set including a destination IP address and port of the network session.

18. A server computer operable to discover or build relationships between users, user devices, software applications, and/or data of a network, the server computer comprising:
a processor; and
memory containing instructions that, when executed by the processor, cause the server computer system to:
identify a network session of a user device accessing a software application;
retrieve, from a network device, information of the network session including a set of source IP address and port, a set of destination IP address and port, and a network protocol;
identify the software application based on the set of destination IP address and destination port and the network protocol;
retrieve a media access control (MAC) address table or a dynamic host configuration protocol (DHCP) log from the network device;
identify a MAC address associated with the source IP address based on the MAC address table or the DHCP log;
determine an identity of the user device based on the identified MAC address; and
record the network session associating an identity of the user device with an identity of the software application.

19. The server computer of claim 18, wherein the software application is a cloud-based application residing on a remote server accessible by the user device over a wide area network.

20. The computer-implemented method of claim 18, wherein the software application resides on a server of a local area network.
